(19) United States
(12) Patent Application Publication
(10) Pub. No.: US 2016/0125145 A1
(43) Pub. Date: May 5, 2016

(54) APPARATUS, SYSTEM AND METHOD FOR DISPLAYING MEDICINE-TAKING INFORMATION

(71) Applicant: LG CNS CO., LTD., Seoul (KR)

(72) Inventors: JEE HYUN KIM, Seoul (KR); Ki Hwan CHOI, Seoul (KR); Young Kook KIM, Seoul (KR); Hyun Jung PARK, Seoul (KR); Young Don HWANG, Seoul (KR)

(73) Assignee: LG CNS CO., LTD., Seoul (KR)

(21) Appl. No.: 14/528,902

(22) Filed: Oct. 30, 2014

(51) Int. Cl. G06F 19/00

(52) U.S. Cl. CPC G06F 19/326; G06F 19/3456

(57) ABSTRACT

Provided is an apparatus, system, and method related to displaying medicine-taking information, including displaying a first page received from a schedule management server on a display of a patient terminal, the first page including a medicine schedule associated with a particular medicine; displaying a second page separately from the first page on the display, the second page configured for inputting information related to pickup of the particular medicine associated with the medicine schedule; displaying a third page separately from the first page and the second page on the display, the third page including a detailed information button for displaying additional information related to the particular medicine; and transmitting input information for at least the first, second, or third page to the schedule management server.

### BACKGROUND OF THE INVENTION

1. Field of the Invention

Embodiments of the present invention relate generally to an apparatus, system and method for displaying medicine-taking information including information about medicine to be taken in stages depending on the requirements of a patient.

2. Description of the Related Art

Generally, there are very few people who are never required to take medicine at least once throughout their lives, perhaps with the exception of exceptionally healthy people. Further, there are some cases where specific diseases require patients to take medicine consistently throughout their lives.

Expected medication effects may be acquired only when a medicine is taken at regular time intervals depending on the ingredients of the medicine and the duration of the effects of the medicine. However, such regular medicine-taking is very inconvenient, so that medicine-taking schedules are often adjusted within an allowable range to account for the life schedules of ordinary people. For example, certain medicines are taken according to a convenient schedule including “after waking up”, “before meals”, “after meals”, “before bedtime”, etc.

While living in synch with the rhythm of a busy modern society, it is not easy for a person to carefully carry medicine and remember to take the medicine at designated times. Further, if a person forgets to bring his or her medicine, and does not take the medicine or misses a designated medicine-taking time, the effects of the medication are decreased. Furthermore, in some cases, medicine that is not taken during a designated medication period may possibly be misused. Therefore, suitable medicine-taking directions, such as the carrying of medicine, notification of a medicine-taking time, and confirmation of medicine-taking, must be provided to persons who take medicine.

However, in certain environments such as a hospital, a doctor's office, a pharmacy, etc. in which medicines are prepared, medicine-taking procedure is inevitably dependent on the memorization and diligent follow-through of a person taking the medicine, and it is impossible to continually and individually remind each medicine taker to take his or her medicine at each specified time.

Further, medicines have different medicine-taking methods, medicine-taking times, effects, warnings/precautions, etc. depending on the type of medicine. Thus, a problem arises in that it is difficult for patients to understand and cope with such differences.

### SUMMARY OF THE INVENTION

Accordingly, an object of embodiments of the present invention is to provide an apparatus, system and method for displaying medicine-taking information to a patient via a patient terminal in stages.

In accordance with an aspect of the present invention, there is provided a method for displaying medicine-taking information, including separately displaying a first page, a second page, and a third page as a plurality of different pages on a display unit of a patient terminal so that the first to third pages are distinguished from each other, wherein the first page indicates a medicine-taking schedule received from a medicine-taking schedule management server, the second page indicates pickup information input means for receiving pickup information of medicines related to the medicine-taking schedule, and the third page indicates medicine-taking related information including a detailed information button that enables a medicine-taking method and detailed information of each medicine to be viewed; and transmitting input information for at least one of the plurality of pages to the medicine-taking schedule management server.

In accordance with another aspect of the present invention, there is provided an apparatus for displaying medicine-taking information, including a communication unit for receiving medicine-taking information including pickup information of each medicine, a medicine-taking schedule, and a medicine-taking method from a medicine-taking schedule management server, and transmitting input information about the pickup of the medicine, the medicine-taking schedule, and the medicine-taking method to the medicine-taking schedule management server; and a display unit for displaying the pickup information of the medicine, the medicine-taking schedule, and the medicine-taking method in different pages on a display unit of a patient terminal.

In accordance with a further aspect of the present invention, there is provided a system for displaying medicine-taking information, including a medicine-taking schedule management server; and a patient terminal including a communication unit for receiving medicine-taking information including pickup information of each medicine, a medicine-taking schedule, and a medicine-taking method from the medicine-taking schedule management server, and transmitting input information about the pickup of the medicine, the medicine-taking schedule, and the medicine-taking method to the medicine-taking schedule management server, and a display unit for displaying the pickup information of the medicine, the medicine-taking schedule, and the medicine-taking method in different pages on a display unit of a patient terminal.

### BRIEF DESCRIPTION OF THE DRAWINGS

The above and other objects, features and advantages of embodiments of the present invention will be more clearly understood from the following detailed description taken in conjunction with the accompanying drawings, in which:

FIG. 1 is a diagram showing a system for changing a medicine-taking schedule according to an embodiment of the present invention;

FIG. 2 is a diagram showing a medicine-taking schedule management server according to an embodiment of the present invention;

FIG. 3 is a diagram schematically showing the configuration of a patient terminal according to an embodiment of the present invention;

FIG. 4 is a diagram showing a method for displaying medicine-taking information according to an embodiment of the present invention;

FIG. 5 is a diagram showing a first stage medicine-taking information display page according to an embodiment of the present invention;

FIG. 6 is a diagram showing a second stage medicine-taking information display page according to an embodiment of the present invention;

FIG. 7 is a diagram showing a third stage medicine-taking information display page according to an embodiment of the present invention; and

FIG. 8 is a diagram showing a fourth stage medicine-taking information display page according to an embodiment of the present invention.

### DESCRIPTION OF THE PREFERRED EMBODIMENTS

It should be noted that the technical terms used in the present invention are merely used to describe specific embodiments, and are not intended to limit the present invention. Unless differently defined, all terms used in the present invention should be interpreted as having the same meanings as the terms generally understood by those skilled in the art to which the present invention pertains, and should not be interpreted as being excessively inclusive meanings or excessively reduced meanings. Further, when technical terms used in the present invention are technical terms that cannot exactly represent the spirit of the present invention, they must be replaced with technical terms that can be correctly understood by those skilled in the art. Furthermore, the terms used in the present invention should be interpreted based on contents defined in dictionaries or the context, and should not be interpreted as having excessively reduced meanings.

Further, a singular expression used in the present invention includes a plural expression unless a description to the contrary is specifically pointed out in context. In the present specification, the terms such as “include” or “have” should not be interpreted as essentially including all of various components or steps described in the invention, and should be interpreted as excluding some components or steps or further including additional components or steps.

The terms including an ordinal number, such as “first” and “second” used in the present invention may be used to describe various components, but those components should not be limited by the terms. The terms are merely used to distinguish one component from other components. For example, a first component may be designated as a second component and a second component may be designated as a first component in the similar manner, without departing from the scope based on the concept of the present invention.

Hereinafter, embodiments of the present invention will be described in detail with reference to the attached drawings. The same reference numerals are used throughout the different drawings to designate the same or similar components, and repeated descriptions will be omitted.

Further, in the description of the present invention, detailed descriptions of related known technology that make the gist of the present invention unnecessarily obscure will be omitted below. Furthermore, it should be noted that the attached drawings are intended to allow those skilled in the art to easily understand the spirit of the present invention, and the spirit of the present invention should not be interpreted as being limited by the attached drawings.

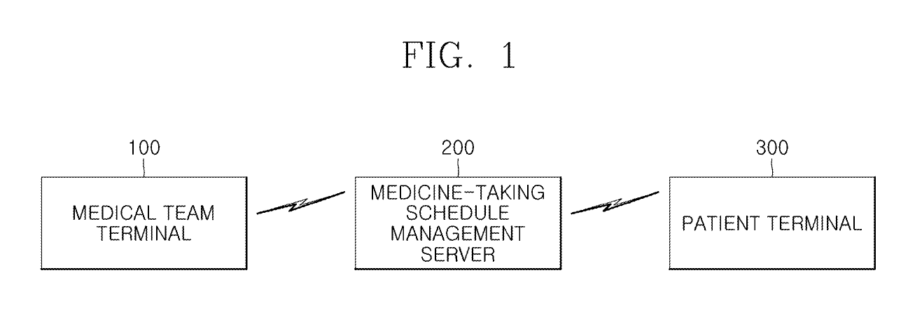

FIG. 1 is a diagram showing a system for changing a medicine-taking schedule, to which a system for displaying medicine-taking information according to an embodiment of the present invention is applied. As shown in the drawing, the system for changing a medicine-taking schedule according to the embodiment of the present invention includes a medical team terminal 100, a medicine-taking schedule management server 200, and a patient terminal 300.

The medical team terminal 100 and the patient terminal 300 are devices for providing a medical supply information service, a medical supply-taking guide service, etc. for medicine-taking management to a user according to the present embodiment, and may include various types of terminals such as a mobile phone, a personal digital assistant (PDA) phone, a Personal Communications Service (PCS) phone, an International Mobile Telecommunications-2000 (IMT-2000) terminal, a smart phone, a laptop computer, a notepad, a television, a smartwatch, and the like.

The medical team terminal 100 and the patient terminal 300 may be connected to a network via Broadband Wireless Access (BWA) and may be provided with a wireless communication service or a wired communication service. The network may include all types of wireless environments which support not only second generation communication based on Code Division Multiple Access (CDMA), but also Wideband Code Division Multiple Access (W-CDMA)-type third generation or higher wireless communication technology, and the like.

The medical team terminal 100 is a terminal used by a medical team which provides a medical service, and functions to input a prescription and comments about medicine-taking, and to transfer the information to the medicine-taking schedule management server 200.

The patient terminal 300 is a terminal used by a patient who is provided with the medical service, and performs functions of receiving and checking a medicine-taking schedule, checking the comments input by the medical team terminal 100, checking medicine-taking information, inputting the details of medicine already taken, and displaying the medicine-taking information.

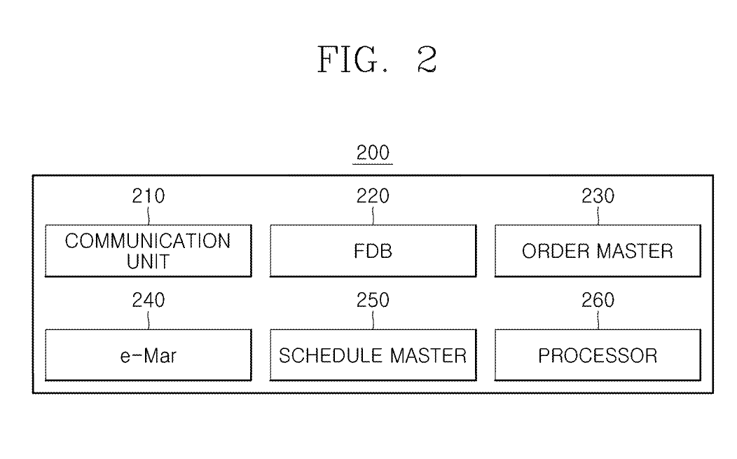

The medicine-taking schedule management server 200 may be connected both to the medical team terminal 100 and to the patient terminal 300 through the network, and may receive information from one of the terminals, and store the received information and transfer the information to the other terminal if necessary. Further, the medicine-taking schedule management server 200 may store the identification information of the patient, for example, information about the gender, age, phone number, past medicine-taking history information, prescription information, related medical supplies, etc. of the patient. Detailed configuration and operation of the medicine-taking schedule management server 200 will be described in detail below with reference to FIG. 2.

FIG. 2 is a diagram showing the medicine-taking schedule management server according to an embodiment of the present invention. The medicine-taking schedule management server 200 according to the embodiment of the present invention may include a communication unit 210, a MDB (Medicine Database) 220 (discussed in further detail below), an order master 230 (discussed in further detail below), an electronic Medication Administration Record (eMAR) memory 240, a schedule master 250, and a processor 260.

The communication unit 210 performs data communication with both the medical team terminal 100 and the patient terminal 300 through the network. Accordingly, the communication unit 210 allows the medicine-taking schedule management server 200 to receive and store information input from one terminal, and to transfer the input information to the other terminal if necessary.

The MDB 220 is a database (DB) for storing information about medicine-taking, such as a form of medicine, a route (medicine absorption route in a body), a medicine-taking time, and a medicine-taking time interval.

The order master 230 is a DB for managing pieces of data about medicine-taking, based on the information stored in the MDB 220.

The eMAR memory 240, which is configured to store medicine-taking information of each patient, stores information such as a medicine-taking time, the name of a taken medicine, and the dosage of the taken medicine.

The schedule master 250 is a DB for storing the final medicine-taking schedule of the patient. Further, the schedule master 250 may store the identification information of the patient, for example, the age, gender, phone number, past medicine-taking history information, prescription information, and related medical supplies of the patient.

A processor 260 is a component for processing the data of the medicine-taking schedule management server 200.

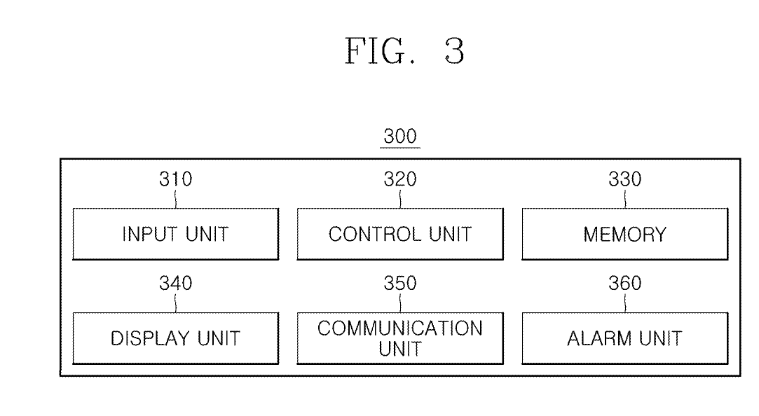

FIG. 3 is a diagram schematically showing the configuration of the patient terminal according to an embodiment of the present invention. The patient terminal 300 according to the embodiment of the present invention includes an input unit 310, a control unit 320, a memory 330, a display unit 340, a communication unit 350, and an alarm unit 360.

The input unit 310 generates input data to control the operation of the patient terminal 300. The input unit 310 may be implemented using a keypad, a dome switch, a touch pad (resistive/capacitive type), a jog wheel, a jog switch, or the like.

The control unit 320 controls the overall operation of the patient terminal 300, and performs, for example, related control and processing for a voice call, data communication, a video call, etc. The control unit 320 may perform pattern recognition processing that enables a written input or a touch input to be recognized as characters.

The memory 330 may store a program for the operation of the control unit 320, and store pieces of input/output data. The memory 330 may include at least one type of storage medium including flash memory, a hard disk, a multimedia card, other card-type memory (e.g., Secure Digital (SD) or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, a magnetic disk, an optical disk, and the like.

The display unit 340 displays (outputs) information processed by the patient terminal 300. For example, when the patient terminal 300 is in a call mode, the display unit 340 displays a User Interface (UI) or a Graphical User Interface (GUI) related to a call. When the patient terminal 300 is in a video call mode or an image capturing mode, the display unit 340 displays a captured image and/or a received image, or an associated UI or GUI.

The display unit 340 may include various types of display technology such as a liquid crystal display (LCD), a thin film transistor-liquid crystal display (TFT LCD), an organic light-emitting diode (OLED), a flexible display, or a three-dimensional (3D) display, and the like.

When the display unit 340 and a sensor for sensing a touch action (hereinafter referred to as a “touch sensor”) form a mutual-layered structure (hereinafter referred to as a “touch screen”), the display unit 340 may also be used as an input device as well as an output device.

The touch sensor may be configured to convert a variation in pressure applied to a specific portion of the display unit 340 or a variation in capacitance into an electrical input signal.

The communication unit 350 may include one or more modules enabling wireless communication between the patient terminal 300 and a wireless communication system. For example, the communication unit 350 may include a broadcast reception module, a mobile communication module, a wireless Internet module, a short-range communication module, a location information module, and the like.

The wireless Internet module may include a module for accessing the wireless Internet, and may be installed inside or outside the patient terminal 300. Wireless Internet technology, Wireless LAN (WLAN) such as Wi-Fi, Wireless broadband (Wibro), World Interoperability for Microwave Access (Wimax), High Speed Downlink Packet Access (HSDPA), and the like may be used.

The short-range communication module may include a module for short-range communication. Short-range communication technology, Bluetooth, Radio Frequency Identification (RFID), Infrared Data Association (IrDA), Ultra Wideband (UWB), ZigBee, and the like may be used.

The alarm unit 360 outputs a signal for providing notification of the generation of an event in the patient terminal 300. Examples of events generated in the mobile terminal include call signal reception, message reception, key signal input, touch input, etc. The alarm unit 360 may also output a signal for providing notification of generation of an event in various forms of notifications, for example, in the form of a vibration. A video signal or the audio signal may also be output via the display unit 340 or an audio output module.

Although the above description is related to the components of the patient terminal 300, similar components may be applied to the medical team terminal 100.

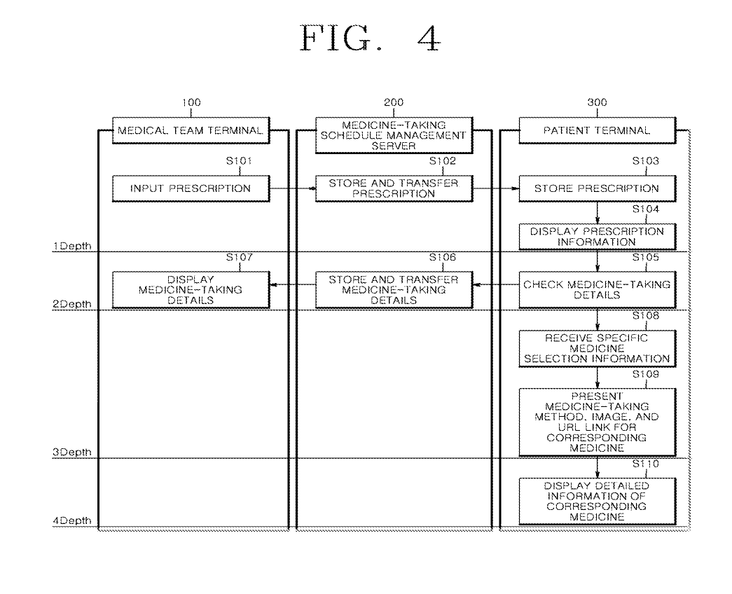

FIG. 4 is a flowchart showing an example of a method for displaying medicine-taking information according to an embodiment of the present invention. Referring to FIG. 4, the medical team terminal 100 inputs a prescription at block S101, and transfers the prescription to the medicine-taking schedule management server 200 through the communication unit. The prescription includes information such as the name of each medicine to be taken, a medicine-taking (dosage) period, a medicine-taking time, warnings/precautions for the taking of the medicine, patient information, and a prescription transfer time.

The medicine-taking schedule management server 200 receives the prescription, stores the prescription therein, and transfers the prescription to the patient terminal 300 at block S102. Next, the patient terminal 300 stores the prescription received from the medicine-taking schedule management server 200 at block S103, and displays prescription information on the display unit of the patient terminal 300 at block S104.

An embodiment of a method for displaying the prescription information may include providing an alarm to the patient terminal 300 at a designated medicine-taking time. An example of a notification of the designated medicine-taking time is provided to the patient terminal 300 via an alarm in combination with a voice or text. Further, depending on the setting of the patient terminal 300, a medicine-taking schedule notification service may be deactivated or the corresponding service may be denied. The alarm may be provided in such a way as to display a message indicating that a medicine is to be taken on the patient terminal 300 at a designated medicine-taking time or at a predetermined time before the medicine-taking time.

The user of the patient terminal 300 may check the details of medicine-taking at block S105. The checking of medicine-taking details may be completed by marking a check box displayed on the patient terminal 300 indicating a medicine taken by the patient, among one or more medicines displayed on the patient terminal 300, and then pressing a confirm button. Further, if necessary, previously input medicine-taking details may be changed. In order to improve the reliability of the input of medicine-taking details, a time for which medicine-taking details may be changed may be limited to a specific period.

The medicine-taking details may be transferred from the patient terminal 300 to the medicine-taking schedule management server 200. The medicine-taking schedule management server 200 stores the medicine-taking details received from the patient terminal 300, and transfers them to the medical team terminal 100 at block S106.

The medical team terminal 100 receives the medicine-taking details and displays them at block S107. If necessary, the medical team terminal may transmit a comment about the medicine-taking details to the patient terminal 300.

The patient terminal 300 receives selection information for a specific medicine at block S108, and displays information such as a method of taking the selected medicine, an image of the medicine, and a Uniform Resource Locator (URL) link to the medicine, at block S109. The patient may refer to the selected medicine image to determine whether a medicine to be taken is a prescribed medicine, and may take the medicine with reference to a displayed medicine-taking method.

Further, when the patient selects the URL link, he or she may make a connection to a webpage including the detailed information of the corresponding medicine shown by block S110. The detailed information of the medicine may include information about a medicine storage method, efficacy/effects of the medicine, usage/dosage of the medicine, and warnings/precautions for the use of the medicine. For example, the warnings/precautions for the use of the medicine may include warnings to patients to which the corresponding medicine is to be carefully administered, warnings to patients prohibited from taking the medicine, warnings about allergic and adverse reactions, investigation results after the medicine has been domestically sold, general warnings, and directions for administering the medicine to young children and the elderly. In addition, Internet websites indicating information such as symptoms, cause, complications, prevention of a disease, information about food, physical exercise, and finger-pressure therapy, which are effective in treating the disease, may be provided. A desired website may be accessed depending on the selection of the user and then required information may be viewed.

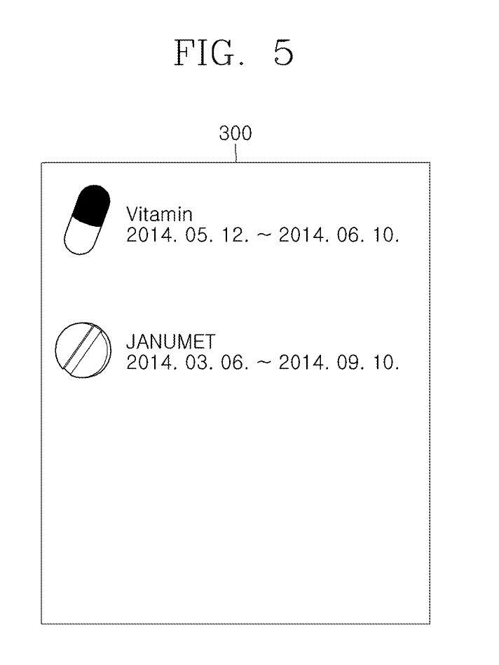

FIG. 5 is a diagram showing a first stage medicine-taking information display page according to an embodiment of the present invention. As shown in the drawing, on the first stage medicine-taking information display page, the name of a new medicine to be picked up and a medicine-taking period are displayed when the new medicine is prescribed. If a pickup completion button is pressed after the medicine has been checked, the patient may go to a second stage medicine-taking information display page in which a detailed medicine-taking schedule is displayed.

When there is more than one type of medicine to be taken, individual types of medicine may be separately displayed, and simple image information of each medicine may be displayed. The shape of each medicine may be referred to via the image information of the corresponding medicine. If the various types of medicine are checked, the patient may go to a page in which individual medicine-taking schedules are merged and represented.

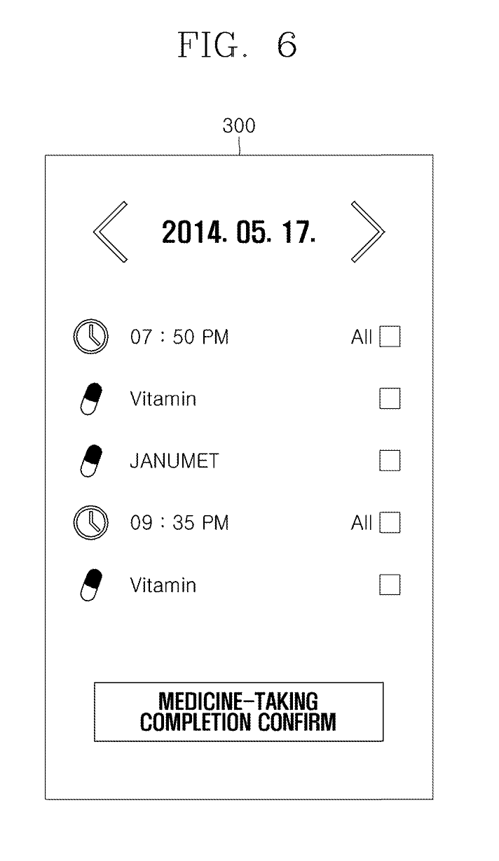

FIG. 6 is a diagram showing a second stage medicine-taking information display page including a medicine-taking schedule page according to an embodiment of the present invention. In a medicine-taking schedule page, information may be displayed including the medicine-taking date and time when each medicine is to be taken, the names, types and dosages of medicine to be taken, and other information related to the medicine or medicine-taking schedule.

If a patient has taken a particular medicine, medicine-taking completion information is transmitted to the medicine-taking schedule management server 200 by selecting check boxes indicating the particular medicine and pressing a medicine-taking completion confirm button.

The medicine-taking completion information may include data about the time when the medicine-taking completion confirm button is pressed. Since there may be a difference between the time when the patient actually took the medicine and the time when the medicine-taking completion confirm button is pressed, information about the time when the patient actually took the medicine may be separately input.

In some embodiments, past information about whether the patient took the particular medicine may be reviewed. Further, a designated medicine-taking time and the time when the medicine was actually taken may be checked. Furthermore, since a future medicine-taking schedule may also be checked, the patient may prepare for a case where medicines are insufficient. If a certain medicine is selected, the patient may go to a third stage medicine-taking information display page in which directions for medicine-taking may be viewed.

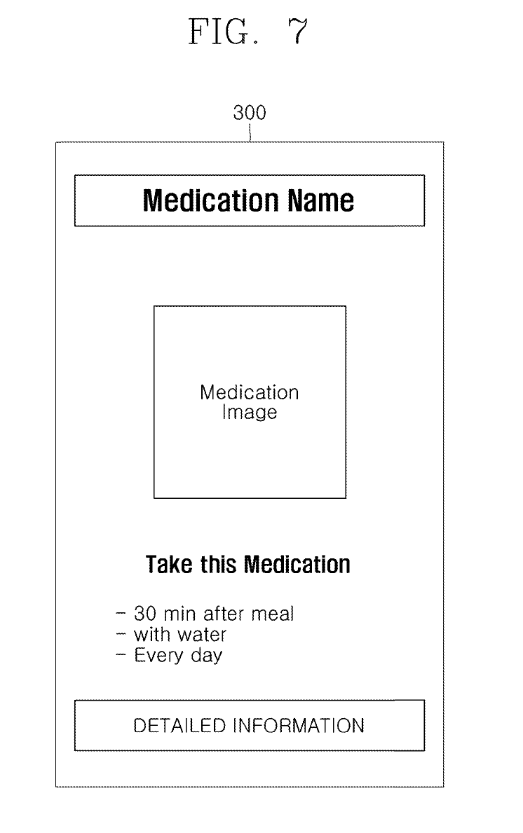

FIG. 7 is a diagram showing a third stage medicine-taking information display page according to an embodiment of the present invention. In the third stage medicine-taking information display page, a simple description of the name of each medicine, a method of taking the medicine, and a medicine-taking time may be displayed, and a detailed information button enabling additional detailed information about the medicine to be viewed may be displayed.

When the image of a particular medicine is selected by various input methods including touch inputs, button inputs, physical input devices, and the like, various images of the particular medicine may also be displayed. When a detailed information button enabling the additional detailed information of a medicine to be viewed is selected, the patient may go to a fourth stage medicine-taking information display page.

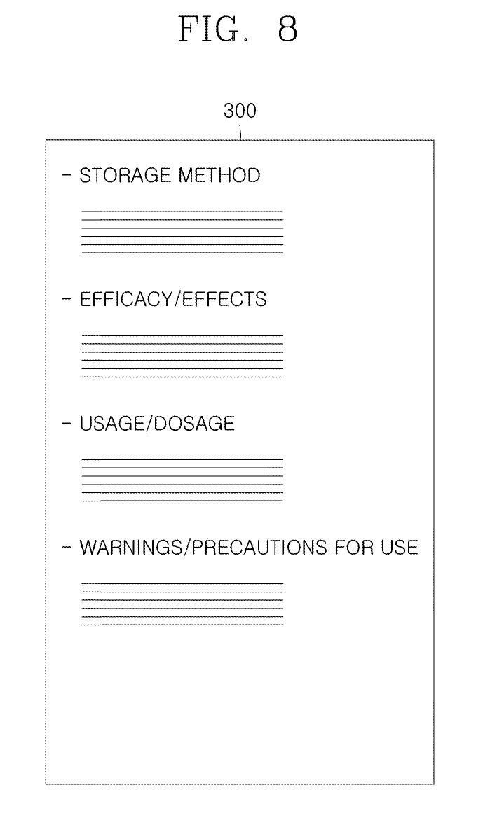

FIG. 8 is a diagram showing a fourth stage medicine-taking information display page. In the fourth stage medicine-taking information display page, information about a medicine storage method, efficacy/effects of the medicine, usage/dosage of the medicine, and warnings/precautions for the use of the medicine may be displayed.

For example, the warnings/precautions for the use of the medicine may include warnings to patients to which the corresponding medicine is to be carefully administered, warnings to patients prohibited from taking the medicine, warnings about allergic and adverse reactions, investigation results after the medicine has been domestically sold, general warnings, and directions for administering the medicine to young children and the elderly. In addition, Internet websites indicating information such as symptoms, cause, complications, and prevention of a related disease, and other information about food, physical exercise, and finger-pressure therapy, which are effective in treating the disease, may be provided. A desired website may be accessed depending on the selection of the user and then required information may be viewed.

In certain embodiments, the patient terminal 300 may receive information from the medicine-taking schedule management server 200 related to the first to fourth stages, store the information in the memory 300, and display information corresponding to a selected stage on the display unit 340 when the patient selects each stage.

In other embodiments, whenever the patient selects stages from the first to fourth stages, the patient terminal 300 may access the medicine-taking schedule management server 200 over the network, receive related information, and display the received information on the display unit 340.

In other embodiments, the patient terminal 300 may receive information from the medicine-taking schedule management server 200, store the received information in the memory 330, and display information corresponding to a selected stage on the display unit 340 when the patient selects each stage, and further, in the fourth stage, when the detailed information is selected, the patient terminal 300 may then access an associated Internet website and displays related information.

According to the discussed embodiments, the patient may check his or her prescription, and also review his or her past medicine-taking history by checking taken medicines.

In certain other embodiments, since an alarm rings at a preset medicine-taking time, medicine-taking compliance may be improved, and various types of information ranging from simple information to detailed information about each medicine may be checked via the patient terminal 300 in stages depending on the requirements of each individual patient.

Thus, in various embodiments of the apparatus, system and method for displaying medicine-taking information a patient may request medicine-taking information for a particular medicine, and detailed information related to the particular medicine may be provided in stages in response to the request.

In other embodiments a medical team may receive and check information related to the medicine-taking condition of a patient, and may provide a comment if necessary.

The above-described details may be changed and modified by those skilled in the art to which the present invention pertains, within the spirit and scope of essential features of the present invention. Therefore, embodiments disclosed in the present invention are not intended to limit the technical spirit of the present invention and are intended to describe the present invention, and the scope of the technical spirit of the present invention is not limited by those embodiments. The scope of the present invention should be interpreted by the accompanying claims, and the technical spirit of equivalents thereof should be interpreted as being included in the scope of the present invention.

Various embodiments described herein may be implemented in a computer-readable medium, a machine-readable medium, or similar medium using, for example, software, hardware, or any combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by a controller or a processor.

The various devices, modules, terminals, and the like discussed herein may be implemented on a computer by execution of software comprising machine instructions read from computer-readable medium. These hardware aspects may further include an input/output interface, graphical user interface, or other input/output means to allow the input/output of information related to controlling functions, inputting information, outputting information, receiving information, or transmitting information. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

The foregoing disclosed embodiments and features are merely exemplary and are not to be construed as limiting the present invention. The present teachings can be readily applied to other types of apparatuses and processes. The description of such embodiments is intended to be illustrative, and not to limit the scope of the claims. Many alternatives, modifications, and variations will be apparent to those skilled in the art.

What is claimed is:

1. A method for displaying medicine-taking information, comprising:
receiving data associated with the medicine-taking information from a schedule management server;
displaying a first page on a display of a patient terminal, the first page including a medicine schedule associated with a particular medicine;
displaying a second page separately from the first page on the display, the second page configured for inputting information related to pickup of the particular medicine associated with the medicine schedule;
displaying a third page separately from the first page and the second page on the display, the third page including a detailed information button for displaying additional information related to the particular medicine; and
transmitting input information for at least the first, second, or third page to the schedule management server.

2. The method of claim 1, wherein the first, second, and third pages are sequentially displayed.

3. The method of claim 1, further comprising displaying the first page based on information input to the schedule management server by a medical team terminal.

4. The method of claim 1, wherein the information related to pickup of the particular medicine comprises a period for taking the particular medicine, a type of the particular medicine, or a dosage of the particular medicine.

5. The method of claim 1, further comprising displaying information related to the particular medicine and instructions for administering the particular medicine on the third page in response to selection of the particular medicine on the second page.

6. The method of claim 1, further comprising:
displaying a fourth page on the display of the patient terminal in response to a selection of the detailed information button, the fourth page including information related a medicine storage method, effects of the particular medicine, dosage of the particular medicine, or warnings related to the particular medicine,
wherein the warnings comprise information related to patients prohibited from taking the particular medicine, allergic and adverse reactions of the particular medicine, investigation results after the particular medicine has been domestically sold, or directions for administering the particular medicine to young children patients or elderly patients.

7. The method of claim 1, further comprising preparing the information related to pickup for transfer by the schedule management server to a medical team terminal.

8. The method of claim 1, further comprising displaying an alarm on the display corresponding to a designated medicine-taking time.

9. The method of claim 1, wherein the information related to pickup includes data about completion of pickup of the particular medicine.

10. The method of claim 1, wherein the information related to pickup includes data about a time each medicine was taken.

11. The method of claim 1, wherein the instructions for administering the particular medicine includes a name of the particular medicine, an image of the particular medicine, a method for taking the particular medicine, and a time for taking the particular medicine.

12. The method of claim 6, wherein the fourth page is associated with a Uniform Resource Locator (URL).

13. The method of claim 1, further comprising:
receiving the first, second, and third pages from the schedule management server; and
storing the received pages in a memory of the patient terminal.

14. An apparatus for displaying medicine-taking information, the apparatus comprising:
a communication unit configured to transmit and receive information;
a display; and
a controller configured to:
receive information via the communication unit related to pickup of a particular medicine, a medicine schedule, and a medicine administering method from a schedule management server;
transmit via the communication unit at least the information related to pickup, the medicine schedule, or the medicine administering method to the schedule management server; and
cause the display to display the information related to pickup, the medicine schedule, and the medicine administering method on a plurality of different pages.

15. A system for displaying medicine-taking information, the system comprising:
a schedule management server; and
a patient terminal configured to:
receive information including pickup of each medicine, a medicine schedule, and a medicine administering method from the schedule management server, and
transmit input information about at least information related to the pickup of the medicine, the medicine schedule, or the medicine administering method to the schedule management server,
wherein the patient terminal comprises a display configured to display the information related to pickup of the medicine, the medicine schedule, and the medicine administering method on a plurality of different pages.
